(19) United States
(12) Patent Application Publication
(10) Pub. No.: US 2001/0045393 A1
(43) Pub. Date: Nov. 29, 2001

(54) METHOD FOR LOWERING PH IN LEATHER PROCESSING SOLUTIONS

(76) Inventors: R. RICHARD SARGENT, ROME, GA (US); JEFFREY RANDOLPH ALENDER, MARIETTA, GA (US); THOMAS HUDSON MOSS III, ROME, GA (US)

Correspondence Address: JOHN S PRATT, KILPATRICK STOCKON, 1100 PEACHTREE STREET, SUITE 2800, ATLANTA, GA, 303094530

(21) Appl. No.: 08/847,042

(22) Filed: May 1, 1997

Related U.S. Application Data
(63) Continuation-in-part of application No. 08/233,348, filed on Apr. 25, 1994, now Pat. No. 5,672,279.
Application No. 08/233,348 is a continuation-in-part of application No. PCT/US93/06995, filed on Jul. 26, 1993.
(63) Continuation of application No. 07/919,523, filed on Jul. 24, 1992, now Pat. No. 5,234,466.
(63) Continuation-in-part of application No. 08/416,093, filed on Apr. 4, 1995, now Pat. No. 5,733,463.
Application No. 08/416,093 is a division of application No. 08/280,189, filed on Jul. 25, 1994, now abandoned.
Application No. 08/280,189 is a continuation-in-part of application No. 07/919,523, filed on Jul. 24, 1992, now Pat. No. 5,234,466.

(51) Int. Cl. C02F 1/00

(52) U.S. Cl. 210/698

(57) ABSTRACT

The present invention relates to methods for lowering the pH of leather processing solutions by adding a pH reduction agent that is urea sulfate, urea hydrochloride, triethanolamine hydrochloride, or triethanolamine sulfate as a replacement for conventional pH lowering acids, such as sulfuric acid, formic acid, acetic acid, etc. The invention may be used with respect to any leather processing step that requires pH adjustment, including deliming, pickling, tanning, dyeing, finishing, and retanning. The pH lowering method of the invention results in safer handling, more environmentally acceptable effluents, and decreased corrosion of process equipment.

This application is a continuation-in-part of U.S. Ser. No. 08/233,348, filed on Apr. 25, 1994, which is a continuation-in-part of PCT/US 93/06995, filed on Jul. 26, 1993, which is a continuation of U.S. Ser. No. 07/919,523, filed on Jul. 24, 1992, now U.S. Pat. No. 5,234,455, the entire contents of each of which is hereby incorporated by reference.

This application is a continuation-in-part of U.S. Ser. No. 08/416,093, filed on Apr. 4, 1995, which is a divisional of U.S. Ser. No. 08/280,189, filed on Jul. 25, 1994, which is a continuation-in-part of U.S. Ser. No. 07/919,523, filed on Jul. 24, 1992 now U.S. Pat. No. 5,234,455, the entire contents of each of which is hereby incorporated by reference.

### BACKGROUND OF THE INVENTION

1. Field of the Invention

The present invention relates to methods for adjusting pH in processes for producing leather by treating and processing skins or hides, including pretanning, tanning, dyeing, and finishing processes for converting hides, skins, or pelts into a leather or tanned skin. The pH adjustments needed for such processes may be accomplished by replacing conventionally used acids with a more environmentally friendly, less toxic, less hazardous salt of a pH reduction agent selected from the group consisting of urea sulfate, urea hydrochloride, triethanolamine sulfate, and triethanolamine hydrochloride.

2. Description of the Related Art

Leather is a biological fabric material typically made by chemically processing animal hides that consist of mostly water, dry materials, and ash. The dry materials in a typical hide are largely made up of fibrous proteins, such as collagen, keratin, elastin, and reticulin. The ash typically includes phosphorus, potassium, sodium, arsenic, magnesium, and calcium. Methods for processing leather typically involve steps of preparing skins for tanning, the tanning process itself, optionally dyeing the leather, and optionally finishing the tanned, or tanned and dyed leather. Each of these processes involves the use of various chemicals, e.g., acids and bases, to adjust pH, or to modify other aspects of the process. The tannery and leather dyeing industry has, in recent years, attempted to reduce volume of the waste effluents generated by the tanning and dyeing processes.

Nevertheless, leather has unique properties that make it a desirable material for a number of products, including its flexibility, elasticity, water barrier properties, and breathability. For instance, the flexibility of leather allows it to conform to the shape of a human foot or hand, while its elasticity allows it to retain its shape as a shoe or glove. Its water barrier properties provide protection from the elements, while its breathability allows perspiration and moisture to be carried away from the skin. These properties make leather ideally suited as a fabric for making shoes or gloves, as well as a material for a wide range of applications. This suitability, together with the relative ease with which the properties of leather can be modified to prepare fabrics suitable for a variety of uses, results in a heavy demand for leather and leather products, which does not seem likely to diminish in the absence of synthetic leather-like materials that can duplicate these properties and provide the appearance and feel of leather.

Accordingly, there has been, and continues to be, a need for processes that can produce leather of acceptable quality, but that do not generate the volume or type of polluting effluents that have come to be associated with the leather production industry.

A variety of tanning processes may be used to tan leather, including chrome, or “blue” tanning, vegetable tanning, and tanning with phenolic type and acrylic type polymers of low molecular weight (hereafter “polymer tanning”). Typically, the starting material that is received by the tannery is in the form of hides that have been cured with salt or brine. These hides are first soaked to remove the salt, and to rehydrate the hide material. The rehydrated hides are then treated to remove hair (the so-called dehairing or unhairing process). Dehairing is typically accomplished by a series of steps, including physical removal of the hair (e.g., by scraping), liming, deliming, and optionally bating.

Liming involves the treatment of the rehydrated hide with a solution of hydrated lime (calcium hydroxide), sodium sulfide/sulfhydrate, arsenic sulfide, sodium cyanide, sodium hydrosulfite, or dimethylamine sulfate, or combinations thereof, in order to loosen hair and swell the collagen fibers, separating them and opening up the structure of the hide to the tanning agent to be applied later. This will allow better and faster penetration of the tanning agent into the leather. Liming also provides additional free carboxyl groups on the protein molecules of the hide by hydrolyzing amide side chains. These free carboxyl groups become important during the subsequent tanning step in that they provide additional sites reactive with the tanning agent. The length of the liming step can vary, but typically lasts from about 4 to about 16 hours.

The liming step is followed by a deliming step, where the pH of the relatively basic liming solution containing the limed hide is lowered, typically by adding an acid solution. Lowering of the pH is necessary in order to carry out the subsequent bating and pickling steps in the tanning process.

Bating involves the treatment of delimed hides with an enzyme, typically with pancreatin or other tryptic enzyme, to remove excess proteins, such as any remaining hair. Bating also modifies the softness and grain of the leather product of the tanning process, with a longer bating time resulting in softer, smoother-grained leather. Whether bating is used, and the extent to which it is used, depends on the properties desired in the final leather product. Leather used for the soles of shoes can be produced with little or no bating, while soft kid skins for gloves might require bating times of 10 hours or more.

Other, non-lime unhairing systems also exist, including the use of alkaline reducing systems such as ammonium hydroxide, dimethylamine sodium hydroxide, as well as oxidizing systems such as chlorine dioxide/glycolic acid. The oxidizing systems require a shift of the pH of the treatment system from alkaline to acid.

The dehaired, and optionally bated, hides are then pickled with acid, typically sulfuric acid or formic acid, to lower the pH of the solution, typically to less than about 3. The hide is then ready for the tanning process.

The object of any tanning process is to stabilize the collagen fibers of the hide so that they are no longer biodegradable. The conventional chrome, or “blue,” tanning process that is used in producing about 90 % of the leather processed in the United States, uses a trivalent chromium salt tanning agent. The pickled hides are contacted with an aqueous solution of the trivalent chromium salt, e.g., basic chromium sulfate, at a pH sufficiently low that the chromium salt is soluble and capable of greater penetration into the hide. A typical tanning solution containing chromium sulfate has a pH of below about 2.8 (and has a basicity of 30 - 50 %, typically about 33 %). The “basicity” of the chromium solution refers to the percent of primary valence bonds of the chromium in solution accompanied by hydroxyl groups. The tanning solution remains in contact with the pickled hides for sufficient time to allow complete penetration, after which the pH is slowly increased by the addition of a base, typically sodium bicarbonate. The tanning process may be controlled by adding to the tanning solution various compounds that act as masking agents, such sodium formate, or other compounds that generate anions having complexing affinity for the chromium tanning agent. In addition, control of the pH of the tanning bath is important to prevent tanning agent from precipitating and to allow tanning to occur evenly. As the pH of the tanning solution is increased, various chromium species in the tanning solution crosslink the protein molecules in the hide by reacting with free carboxyl groups on the protein molecules. Complete reaction has generally been obtained by the time that a pH of 3.4 - 3.6 has been reached.

Tanned hides may be dyed, or allowed to stand for a period of time, typically overnight, to allow the chromium to more completely fix into the protein of the leather, usually collagen.

Although of decreasing importance in the U.S., dehaired, delimed (and/or bated), and (lightly) pickled hides may also be tanned using a vegetable tanning process involving contacting the hides with tannins, typically polyphenolic compounds, obtained as water soluble extracts of plant materials, such as wood, bark, leaves, fruits, pods, and/or roots of, e.g., quebracho, myrobalans, sumac, gallnuts, gambier, mangrove, hemlock, chestnut, vilonia, or lignosulfonates. This tanning process is typically much slower than chrome tanning, requiring several days of soaking the hides in the tanning solution. However, the resulting leather typically has a characteristic fullness and resiliency, making it suitable for shoe soles, belts, saddles, upholstery, lining, and luggage. A more rapid variation of the traditional vegetable tanning process is known as the Liritan process. In this process, limed and bated hides are treated with a 5 % solution of sodium hexametaphosphate and sufficient sulfuric acid to achieve a pH of 2.8 prior to tanning. This treatment allows subsequent tanning with vegetable tannins to occur in a considerably shorter time.

It is not believed that crosslinking of the protein molecules occurs to any great extent in vegetable tanning. Subsequent treatments to vegetable tanned leather may include surface cleaning to remove excess, unbound tannins, wringing to remove excess water, oiling, rolling with a metal roller to pack the fibers and impart a characteristic gloss, dyeing, drying, dip-washing in wax, etc. Removal of unbound, excess tannins from the surface of the leather may be carried out by dipping the leather into an acid or alkali solution.

Polymer tanning involves the use of synthetic resins or polymers as tannages. These polymer tannages may include sulfonated novolak resins, methylol compounds of nitrogen bases (such as methylol or dimethylolureas, dimethylolurea ether, dimethylolthiourea, methylolamine, and condensation products of dicyandiamide and formaldehyde, methylol-melamine), and styrene-maleic anhydride copolymers. For instance, when the tannage is a methyol-based polymer, this polymer is formed in the tanning solution by lowering of the pH with, e.g., sulfuric acid or formic acid. When the tannage is a styrene-maleic anhydride copolymer, the hide is depickled with aqueous base to raise its pH, then contacted with soluble resin at a pH of around 5. Then the pH of the solution is adjusted to around 3.5 to precipitate the copolymer tanning agent in the leather.

A typical polymer tanning process is described below.

| | | |
|---|---|---|
| TANNING AGENT | LEUKOTAN 974 | |
| | LEUKOTAN 1028 | |
| RAW MATERIAL | Blue Stock Shaved 1.0-1.4 | |
| | ozs. | |
| PROCESS FOR: | Retanning | |
| BASIS: | Blue Shaved Weight | |
| WASH: | 200% Water 115° F. (45° C.) | Run 10 minutes |
| RETAN: | 100% Water 100° F. (40° C.) | Run 20 minutes |
| | 2% Leukanol D-48 | |
| | 2.5% Chrome (33% Basic) | Run 30 minutes |
| ADD: | 10% Water 100° F. (40° C.) | Run 20 minutes |
| | 1% Sodium Formate | |
| | 0.5% Tannigan PC | |
| ADD: | 3% Leukotan 974 | Run 45 minutes |
| | 4% Leukotan 1028 | |
| | 2% Dyestuff | |
| ADD: | 50% Water 150° F. (70° C.) | Run 60 minutes |
| | 6% Coripol BZN | |
| | 1% Raw Neats | |
| | 6% Monte G-82 | |
| ADD: | 1% Formic Acid | Run 10 minutes |
| WASH: | Cold | Run 5 minutes |

The tanning processes discussed above may be preceded or followed by various pre- and posttanning processes that are used to provide additional properties to the final leather product, and include mineral tannages (such as zirconium tannage, aluminum tannage, iron tannage, polyphosphate tannage, or silica tannage), polyphenolic or acid naphthalene syntans, resin tannages, oil tannage, sulfonyl chloride tannage, and aldehyde tannage. Alternatively, these processes may be carried out as the primary tannage.

Leather that has been initially tanned experiences a gradual decline in pH as a result of a number of chemical processes, including increased chrome fixation. Often it is necessary or desirable to adjust the pH by neutralizing the leather, and retanning the leather one or more times to develop desired properties for different end uses of the leather. These retanning steps may occur before or after dyeing of the leather, and may be followed by a fat-liquoring step, involving treating the leather with an oil-in-water emulsion or other procedure for replacing oils removed during leather processing and enhancing the physical properties of the leather. Drying of the leather helps to complete reactions of the tanning agents, dyes, fat liquors, etc. with the leather fibers, and to bring the water content near to that of the final product.

Dyeing of the tanned leather involves contacting the leather with dyestuff solutions for sufficient times, and under sufficient conditions to bind the dyestuff to the leather. Leather dyeing is generally done as a batch process, for example in a drum or vessel equipped with paddles, or by applying the dye to the leather with a brush, a spray, or by immersing the spread out leather in a shallow pan or tray. Acid dyes will fix more readily to leather at low pH values, and fixation may be accomplished by lowering the pH of the dyeing solution once the acid dye has penetrated the leather. Typically, this is done by adding a weak acid, such as formic acid, to the dyeing solution

Typical dyeing processes are described below. Percentages are by weight, based upon the total weight of the leather.

### Dyeing Process 1

| | |
|---|---|
| LOAD | 5/8 oz.- 60 Dbl. Backs (1450 lbs) |
| WASH | 10 mins., cold water, slat door |
| FLOAT | to cover stock |
| ADD | 1.5% Amm. Bicarb. |
| | Run 2 hours, set overnight |
| | Check for pH of 5.5-6 and adjust as necessary |
| ADD | 2% Tamol SD (29 lbs) |
| | 1% Wattle (14.5 lbs) |
| | 1.5% Sod. formate (21.75 lbs) |
| | 3% Bayoil 3182-G |
| | Added through door |
| | Run 30 mins. |
| ADD | 4% Black R (58 lbs) |
| | Start Mill |
| ADD | 1% Aqua Ammonia (14.5 lbs) |
| | Run 4 hours - check pent. |
| ADD | 2% Eureka 525 (29 lbs) |
| | 1% Raw neats foot oil (14.5 lbs) |
| | Run 20 mins. |
| ADD | 3% Baywax All-G (43.5 lbs) |
| | Run 20 mins. |
| ADD | 2% Formic acid (29 lbs) |
| | Run 20 mins. |
| WASH | 7 mins, 120° F., slat door |
| FLOAT | to door, 120° F. |
| | Run 5 mins. |
| ADD | 0.14% Basic Black 3 MKE (2 lbs) |
| | 0.14% Acetic acid (2 lbs) |
| | Mixed together into a paste with hot water |
| | Run 20 mins. |
| PULL | Horse, set overnight |

### Dyeing Process 2

| | |
|---|---|
| LOAD | ⅝ oz. leather |
| WASH | 7 mm., 120° F., slat door |
| FLOAT | high 120° F. |
| ADD | Aluminum sulfate |
| | Salt |
| | Sodium formate |
| | Trastan TQ |
| | Tartrazine |
| | through door |
| | Run 30 min. |
| ADD | Tamol S D |
| | Run 10 min. |
| ADD | Leather Brown CL |
| | Leather Maroon TC |
| | Alum Brown THN |
| | Tamol S D |
| | Mixed together in a past with cold water, then |
| | added to enough hot water to dissolve well |
| | Run 30 min. |
| ADD | Bayoil 3182-G |
| | Raw neats foot oil |
| | Run 45 min |
| ADD | Formic acid |
| | Run 20 min. |
| PULL | Horse overnight, tack |

Tanned and/or dyed leather can then be finished by application of natural or synthetic polymers and/or colorants onto and within the leather surface to produce a uniform surface, abrasion resistance, water repellency, etc. For instance, acrylic polymers, blends of fluoropolymers and acrylic polymers, and/or silicon polymers of differing molecular weights can be used to impart water repellency and hand feel finish.

The processes described above are all known in the art of leather production and make use of various acids and other pH adjustment agents to adjust the pH of process solutions so that the tanning and dyeing steps can function effectively. The use of these agents, heretofore thought necessary to have an operable process, causes problems involving the handling of the acids themselves and the process streams containing them (relating to both worker exposure and corrosion of process equipment) and effluent stream discharge of pollutants into the environment. It is an object of the present invention to provide a pH adjusting agent that can be used as a replacement for the conventional acids used in leather processing, but that provides improved safety and handling characteristics, both for the material itself and for process streams wherein it has been used, as well as decreased environmental impact resulting from discharge of leather processing effluent streams into the environment.

In addition, the above represents a general description of leather production processes. Individual processes may vary depending on the type of hide or skin being processed into leather, the grade, quality, and intended use of the leather produced, and other factors well known to those familiar with leather processing. These processes may include process steps different from those discussed above, and may omit some of the steps described above. Leather processing is discussed in more detail in O'Flaherty et al., eds., The Chemistry and Technology of Leather, vols. I-IV, Reinhold Publishing Corp., N.Y., 1956-1965, and in Thorstensen, Practical Leather Technology, Robert E. Krieger Publishing Co., Inc., Huntington, N.Y., 1975, each of which is incorporated herein by reference.

### SUMMARY OF THE INVENTION

The present invention relates to the use of a pH adjustment agent that is selected from the group consisting of urea sulfate, urea hydrochloride, triethanolamine hydrochloride, and triethanolamine sulfate, as a partial or total replacement for the acids used in the leather treatment processes described above. More particularly, these pH adjustment agents can be used to partially or completely replace sulfamic acid, phosphoric acid, sulfuric acid, formic acid, acetic acid, citric acid or glycolic acid (hydroxyacetic acid) wherever these acids are used in leather processing. The pH adjustment agents can also be used to replace other pH adjustment chemicals, such as ammonium sulfate or ammonium chloride, in leather processing solutions. As used herein, the term “leather processing” includes, in addition to the specific processes and process steps described above, any method or steps for the preparation of leather from a hide or skin. Leather processing methods are described in O'Flaherty et al., eds., The Chemistry and Technology of Leather, and in Thorstensen, Practical Leather Technology.

The pH adjustment agents according to the present invention are capable of providing greater pH reduction than acetic acid or formic acid, and do not have the corrosion or volatility characteristics of sulfuric acid, hydrochloric acid, or other conventional acids, are easy to store and handle, are completely soluble in water, and can be used over a wide range of temperatures.

The pH adjustment agents in accordance with the present invention, can be used to replace conventional acids or other pH adjustment agents in dehairing or unhairing, deliming of hides or skins, to replace formic acid or sulfuric acid in the pickling of limed hides, to replace conventional acids for neutralizing the tanning bath to prepare for dyeing, to remove excess tannins from the surface of the leather, and to replace conventional acids to set the fat liquor during fat liquoring. The pH adjustment agents of the present invention can also be used to replace conventional acids in adjusting pH during dyeing operations, such as to replace formic acid as a dye fixative, or to adjust pH of the dyebath or at the end of a color run, or to level color. Replacement may be partial or total. As a result, these solutions may be substantially free of other pH reduction agents, including the acids discussed above. As used herein, the term “substantially free” indicates that any amounts of these components present are insufficient to cause a significant reduction in the pH of the solution.

The pH adjustment agents of the present invention can be used in leather treatment processes in the same manner as the conventional acid that the pH adjustment agent replaces, but do not require the same level of precautions and safe handling procedures needed to use a conventional acid.

In one embodiment, the invention as disclosed is a method for adjusting pH during leather processing that includes the addition of pH adjustment agents according to the invention to an aqueous leather processing solution, such as the solutions used to delime, pickle, tan, finish, or dye hides. The pH adjustment agents can be formed with any desired ratio of the individual components that performs the desired function. Examples of suitable urea sulfate salts include those formed by combining between 1:4 and 4:1 moles of urea with sulfuric acid, more usually between 2.5 and 0.25 moles of urea with one mole of sulfuric acid, or between 2.0 and 0.5 moles of urea to sulfuric acid. A particular ratio found to be suitable is approximately one mole of sulfuric acid to one mole of urea, or alternatively, a slight molar excess of urea. Similar ratios can be used to prepare urea hydrochloride, triethanolamine hydrochloride, and triethanolamine sulfate agents.

The use of the pH adjustment agents of the present invention to adjust pH in leather processing solutions has advantages over conventional methods of pH adjustment in leather processing, which involve using conventional strong acids, such as sulfuric, sulfamic, acetic, or formic acid. Traditional chemicals used for pH adjustment in leather processing include sulfamic acid, formic acid, acetic acid, sulfuric acid, phosphoric acid and combinations thereof. These conventional pH adjusters can exhibit one or more disadvantages, such as low efficiency (i.e., require large amounts of chemical for the desired effect), high cost, difficulty in handling, hazards in handling, corrosiveness, or high acidity of the resulting effluent stream. The pH adjustment agents of the present invention are less corrosive to metal equipment and other contact surfaces when heated than the equivalent amount of conventional acid. Further, the pH adjustment agents of the present invention, in particular urea sulfate, may decompose under heat or catalytic conditions (including acidic pH) to, in the case of urea sulfate, carbon dioxide and ammonium sulfate. These decomposition products have a decreased tendency to lower the pH of effluent streams, and are less corrosive than traditional chemicals used for pH adjustment in leather processing.

### DETAILED DESCRIPTION OF SPECIFIC EMBODIMENTS OF THE INVENTION

As used herein, the term “hide” refers to any animal skin or pelt that has not yet been tanned. The term “leather processing solution” refers to any solution used in the process of converting hides into leather.

The invention as disclosed is a method to adjust pH in leather processing solutions that includes the use of urea sulfate, urea hydrochloride, triethanolamine hydrochloride, and triethanolamine sulfate in the processing solution. In particular, these pH adjustment agents can be added to deliming baths, pickling baths, tanning baths, dye baths and finishing or retanning solutions to adjust pH in a manner that is often less harmful to the process equipment than with traditional pH adjusters used in leather processing.

It is known that urea decomposes when heated or under certain catalytic conditions to ammonia and CO₂ Although not confirmed, it is hypothesized that the application of heat to a processing solution that includes urea sulfate results in the decomposition of the salt to carbon dioxide and the ammonium salt of sulfuric acid (ammonium sulfate). This decomposition process may result in an effluent that is less acidic, and thus less hazardous to the environment, than an effluent containing traditional pH adjusters.

Since effluent resulting from leather processing that utilizes urea sulfate or the other pH adjusting agents of the present invention may have a higher pH than comparable effluent from leather processing activities using traditional pH adjusters, the urea sulfate-containing effluent requires less neutralization before discharge to the waste water treatment system.

### Preparation of Urea Sulfate

Urea is weakly basic, forming salts with strong acids. Urea sulfate is a salt formed from the simple mixture of urea with sulfuric acid. Common urea sulfate salts include the 1:1 urea to sulfuric acid salt (CAS 21351-39-3), and the 2:1 urea to sulfuric acid salt (CAS 17103-31-0). The 2:1 urea sulfuric acid salt is sold by Aldrich Chemical Company. Any desired ratio of urea to sulfuric acid that performs the desired function of reducing pH to the desired level in a leather processing solution can be prepared by simply mixing the appropriate ratios of components, typically in water. The mixing of urea with sulfuric acid typically results in an exotherm that should be handled with care.

The preferred composition is a solution of sulfuric acid and urea combined in a 1:1 molar ratio or a slight excess of urea, in water. This composition results in a sulfuric acid urea salt solution that has the pH reduction ability of sulfuric acid when used, for example, to reduce the pH of tanning or pickling baths, but is less corrosive than sulfuric acid or sulfamic acid. It is easy to handle and much safer to handle than either sulfuric or sulfamic acid solutions.

### EXAMPLE 1

### Preparation of Urea Sulfuric Acid 1:1 Salt

Prilled urea (17.5 grams, 0.29 moles) was dissolved in 53.5 grams water. To this solution was slowly added sulfuric acid (29.0 grams, 0.26 moles, 89.3%). The temperature was maintained below 50° C. in a cooling bath during the addition. The final solution on titration with 0.5 N NaOH (phenolphthalein indicator) was 6.8 N, which is equal to the theoretical value.

### EXAMPLE 2

### Comparison of Efficiency of Product of Example 1 and Sulfamic Acid in Adjusting pH

The product of Example 1 (44.5% solids, 26% sulfuric acid solution), as well as a 13% solids solution of 1:1 urea sulfate was compared to a 13% solids solution of sulfamic acid in tap water for ability to decrease pH. The results are provided in Table 1. As indicated, a 13% solids solution of sulfamic acid was approximately equal to a 13% solids solution of urea sulfate in ability to reduce pH. However, the 44.5% solids solution of urea sulfate was significantly more efficient at lowering pH than the 13% sulfamic acid solution. Since 15% is the practical concentration limit of sulfamic acid in water, its efficiency as a pH adjuster cannot be significantly increased by increasing its concentration.

TABLE 1

| GRAMS | | | |
|---|---|---|---|
| solids | 13% solids | 13% solids | 44.5% |
| acid/liter | Sulfamic | Urea Sulfate | Urea Sulfate |
| 0 | 7.6 | 7.6 | 7.6 |
| 1 | 3.2 | 3.0 | 2.4 |
| 3 | 2.4 | 2.3 | 1.9 |
| 5 | 2.1 | 2.1 | 1.7 |
| 6 | 2.0 | 2.0 | 1.7 |

### EXAMPLE 3

### Comparison of Corrosivity of Product of Example 1 and Sulfamic Acid

the corrosivity on 316 stainless steel coupons of a 13% solids solution of sulfamic acid and a 13% soilds solution of urea sulfate was compared by immersion of the coupon in the two solutions for 96 hours at 90-100° C. The results are provided in Table 2. As indicated, a 13% urea sulfate solution is less corrosive to 316 stainless steel than a comparable solution by weight of 13% sulfamic acid.

TABLE 2

| | Sulfamic | Urea |
|---|---|---|
| | Acid (13%) | Sulfate (13%) |
| Weight of coupon, initial | 23.00 | 22.55 |
| Weight of coupon, final | 22.67 | 22.48 |
| Weight loss | 0.33 | 0.07 |
| % weight loss | 1.43 | 0.31 |

### EXAMPLE 4

### Preparation of Triethanolamine Sulfate, Triethanolamine Hydrochloride

A sulfuric acid triethanolamine salt useful for pH adjustment in textile processing can be prepared by dissolving triethanolamine in water, and then adding sulfuric acid. Similar procedures can be followed to prepare triethanolamine hydrochloride. The triethanolamine sulfate prepared may be a mixture of tri- and diethanolamine sulfates. For instance, a sulfuric acid (tri and di)-ethanolamine salt useful for pH adjustment in textile processing was prepared by dissolving 41.8 g of an 85/15 mixture by weight of triethanolamine and diethanolamine in 28 grams of water, and then adding 30.2 grams of 89.3% sulfuric acid. The final solids content of the product was 48.9% by weight (28% sulfuric acid).

EXAMPLE 5

### Preparation of Urea Hydrochloride

Urea hydrochloride can be prepared by mixing 62 % by weight, based on the final composition, of 22 ° Be hydrochloric acid with 38 % by weight, based on the final composition, of urea pellets, until a homogeneous mixture is obtained.

Any molar ratio of urea to sulfate, urea to hydrochloride, triethanolamine to sulfate, or triethanolamine to hydrochloride that serves the desired pH adjusting or other purpose can be used within the scope of this invention. Typical ratios, in terms of acid or base equivalents, are typically between approximately 4 to 1 and 1 to 4 acid:base equivalent units or a slight excess of base, in equivalence units. A 1:1 ratio by equivalent units is particularly useful, or slight excess of base.

Any amount of pH adjusting agent can be used, with any molar ratio of individual components, such as urea and sulfuric acid in the case of urea sulfate, that performs the desired function. Given the disclosure herein, one of ordinary skill in the art can easily manipulate the ratio of urea and sulfuric acid, and the amount of salt used, to obtain a desired pH. Methods to determine pH are well known to those of skill in the art. Urea sulfate, urea hydrochloride, triethanolamine hydrochloride, or triethanolamine sulfate is added to the processing solution in any amount to achieve the desired effect, for example, the desired pH. In a preferred embodiment, the pH adjusting agent is added slowly or in small increments until the desired pH is achieved. Methods for measuring pH are well known. In general, the amount of pH adjustment agent to be used will depend upon the particular leather treatment process step and the acid or other pH adjustment agent that is being replaced. Simple titration techniques well known to those of ordinary skill in the art can be used to determine the amount of pH adjustment agent needed to replace the acid or other pH reduction agent and to obtain the desired final pH. For instance, at pH 3, the amount of an 85 wt % aqueous solution of urea sulfate needed is about 50 % of the amount of formic or acetic acid required to achieve the same pH. The amount of the same aqueous solution needed to replace sulfuric acid or hydrochloric acid at this same pH is about 90 wt % more than the corresponding amounts of these acids.

In accordance the present invention, the pH adjustment agents urea sulfate, urea hydrochloride, triethanolamine sulfate, or triethanolamine hydrochloride can be used to replace glycolic acid and other conventional acids for shifting pH in oxidative unhairing systems.

These pH adjustment agents can also be used, as discussed above, to decrease pH in deliming procedures. In these procedures, the pH reduction agents can be used to replace all or part of the conventional acids, ammonium sulfate, or ammonium chloride, and will bring about the gradual lowering of pH needed to avoid differential swelling of the hide.

These pH adjustment agents can also be used to adjust the pH to the optimal pH for the particular enzyme used in bating procedures.

As discussed above, these pH adjustment agents can be used to adjust the pH of pickling baths, whether the pickling bath is used to preserve the leather prior to processing by a tannery, or is used to prepare the delimed hide for tanning.

In the tanning procedure itself, these pH adjustment agents can be used to replace conventional masking agents, such as sodium formate, or acetate or oxalate salts in chrome tanning or to replace citrate or citric acid masking agents in zirconium tanning. These pH adjustment agents are also useful to lower pH in aluminum and zirconium tanning, where the tanning agents develop greater affinity for hide protein at lower pH values than chrome. The pH adjustment agents can be used to replace sulfuric, formic, or other acids used to adjust the pH of methylol-based or styrene-maleic anhydride, or other polymeric tannages to allow the polymer to form in the hide.

The pH adjustment agents according to the present invention can be used to replace formic acid as a pH adjustment agent in the lowering of pH to fix acid dyes on leather.

These pH adjustment agents can also be used to help set the fat liquor emulsions, in particular those made using sulfated oils by reducing the pH of the leather to be fat liquored.

In a particular embodiment of the invention, a urea sulfate composition (NOVOC A-80, 85 % aqueous urea sulfate solution, Peach State Labs, Inc.) has been successfully used to delime ostrich skins and cowhide, as a replacement for formic acid in pickling wool pelts, in the pickling of limed hides, and to neutralize tanning baths to prepare for dyeing. This composition has also been successfully used as a dye fixative in a leather coloring process, to replace formic acid to adjust pH at the end of a color run, and as a formic acid replacement in a 3 feed system to adjust pH in a dyeing operation. Finally, this composition has been successfully used to set fat liquor and to level color during leather finishing.

This urea sulfate composition is added as a clear liquid, and has the following properties:

| | |
|---|---|
| Normality | 16.4 ± 0.2 |
| Percent solids | 85% |
| Density (at 25° C.) | 1.54 ± 0.02 |
| Boiling point | about 100° C. |
| Freezing point | below −10° C. |
| Solubility in water | 100% |
| pH | 1.0 or less |

This composition shows reduced corrosiveness to stainless steel (as compared to conventional sulfuric and other acids), can be more safely handled, has no heat of dilution, and contains no volatile organic substances. The material can be stored in 316 stainless steel, HDPE, polypropylene, or fiberglass containers, and is therefore cheaper to ship and store than conventional acids.

The pH adjustment agents of the present invention may be used in conjunction with any conventional additives used in leather processing, including surfactants, cleaning agents, emulsifiers, tanning agents, etc.

Modifications and variations of the present invention relating to methods to adjust the pH in leather processing solutions will be obvious to those skilled in the art from the foregoing detailed description of the invention. Such modifications and variations are intended to come within the scope of the appended claims.

What is claimed is:

1. A method for lowering the pH of a leather processing solution, comprising:
adding to a leather processing solution a pH lowering effective amount of a salt selected from the group consisting of urea sulfate, urea hydrochloride, triethanolamine sulfate, and triethanolamine hydrochloride.

2. The method according to claim 1, wherein the salt is urea sulfate.

3. The method according to claim 2, wherein said leather processing solution is a deliming solution.

4. The method according to claim 3, wherein said deliming solution is contacted with limed hide prior to bating.

5. The method according to claim 2, wherein said leather processing solution is a pickling solution.

6. The method according to claim 5, wherein said pickling solution is contacted with delimed or delimed and bated hide prior to tanning.

7. The method according to claim 6, wherein the pH of said pickling solution is reduced to less than about 3.

8. The method according to claim 2, wherein said leather processing solution is a tanning solution.

9. The method according to claim 8, wherein said tanning solution comprises an aqueous solution of a chromium salt.

10. The method according to claim 8, wherein said tanning solution comprises an aqueous solution of at least one vegetable tannin.

11. The method according to claim 8, wherein said tanning solution comprises a mineral tannage selected from the group consisting of zirconium tannage, alum tannage, iron tannage, polyphosphate tannage, and silica tannage.

12. The method according to claim 8, wherein said tanning solution comprises a replacement synthetic tannage.

13. The method according to claim 8, wherein said tanning solution comprises a resin or polymeric tannage.

14. The method according to claim 2, wherein said leather processing solution is a leather dyebath.

15. The method according to claim 2, wherein said leather processing solution is a leather finishing solution.

16. The method according to claim 15, wherein said leather finishing solution is a fat liquoring solution.

17. The method according to claim 2, wherein the urea sulfate has an equivalents ratio of urea to sulfuric acid in the range of from 1:4 to 4:1.

18. The method according to claim 17, wherein said equivalents ratio is in the range of from 2.5:1 to 0.25:1.

19. The method according to claim 18, wherein said equivalents ratio is about 1:1.

20. The method according to claim 1, wherein said leather processing solution is substantially free of sulfuric acid, formic acid, and acetic acid.
